(19) United States
(12) Patent Application Publication
(10) Pub. No.: US 2022/0111610 A1
(43) Pub. Date: Apr. 14, 2022

(54) METHOD FOR PRINTING A MULTIFOCAL LENS

(71) Applicant: LUXEXCEL HOLDING B.V., Eindhoven (NL)

(72) Inventor: Tom Verheyen, Eindhoven (NL)

(21) Appl. No.: 17/431,826

(22) PCT Filed: Feb. 19, 2020
(86) PCT No.: PCT/EP2020/054404

§ 371 Date: Aug. 18, 2021

(30) Foreign Application Priority Data
Feb. 20, 2019 (EP) 19158362.4

(51) Int. Cl. B29D 11/00; G02C 7/06; B33Y 10/00; B33Y 40/20; B33Y 80/00; B29C 64/112; B29C 71/04

(52) U.S. Cl. CPC B29D 11/00028; G02C 7/06; B33Y 10/00; B33Y 40/20; G02C 2202/16; B29D 11/00442; B29C 64/112; B29C 71/04; B33Y 80/00

(57) ABSTRACT

Method for printing a multifocal lens (1) with a sharp transition region, comprising a base lens (2) and at least one segment lens (3) comprising the following steps:—virtually slicing the three-dimensional shape of the multifocal lens (1) into two-dimensional slices (9), resulting in a number Nbase of slices ji, . . . , jNbase of the base lens (2) and a number Nsegment of slices i1 . . . , iNSegment of the at least one segment lens (3),—providing a number Nfinish of layers printed as surface-finishing layers (4),—printing the base lens (2) in a base-lens printing step and consecutively printing the segment lens (3) in a segment-lens printing step on top of the base lens (2) through a targeted placement of droplets of printing ink at least partially side by side, wherein in the base-lens printing step first Nbase-Nfinish structure layers (5) and then Nfinish surface-finishing layers (6) are printed and in the segment-lens printing step first NsegmentNfinish structure layers (7) and then Nfinish surface-finishing layers (8) are printed.

### BACKGROUND

The present invention relates to a method for printing a multifocal lens comprising a base lens and at least one segment lens.

Multifocal lenses comprise multiple areas, or fields of vision, providing different optical functions. Bifocal lenses, for example, comprise a near-view area and a far-view area with focal points in the near and in the far distance, respectively. The quality of a multifocal lens crucially depends on the sharpness of the transition between these different areas of the lens.

Traditionally, multifocal lenses are made of mineral or organic glass, i.e. plastic. A bifocal lens made of mineral glass is obtained from a semi-finished (base) lens through integration of an additional segment lens made from a high index glass. The segment lens is ground and polished and placed in an indentation of the semi-finished lens. Through melting of the segment lens, the two lenses are fused together and ground to create a single surface. The sharp transition between base and segment lens is thus naturally obtained through the abrupt change in refractive index at the border between the base lens and the high index segment lens. Bifocal lenses made of plastic or organic glass are obtained through molding. The segment part is directly incorporated into the mold as an area of differing curvature. The sharp transition is hence provided through the abrupt change of curvature at the border between the base area and the segment area.

In recent years, three-dimensional inkjet printing has emerged as a promising and exciting new technology for lens production. As an additive method, it is more flexible and less wasteful than conventional techniques, providing highly individualized, non-standard, low-waste and low-cost prescription lenses. Printing multifocal lenses, however, still remains a challenging task. This is due to the fact that current methods fail to produce the required sharp transition between the different areas, or fields of vision, of the lens. Currently, the base lens is built up layer by layer through a targeted placement of droplets of printing ink. The droplets are typically ejected towards a substrate by ejection nozzles of the print head of an inkjet printer. The segment lens is printed directly on top of the base lens. Hence, a sharp transition results. But in order to obtain a durable lens with the correct optical properties, it is necessary to finalize the overall structure through application of multiple surface-finishing layers to obtain the required surface finish quality and optical strength for ophthalmic lenses. As a result of the surface tension of the applied surface-finishing layers, a meniscus is created at the border between base and segment lens. This meniscus translates into optical aberrations that compromise the quality of the printed multifocal lens.

### SUMMARY

It is a purpose of the present invention to provide a method for printing a multifocal lens with sharp transitions between its areas of differing optical function, or fields of vision, hence providing a multifocal lens of high optical quality, at least matching the quality obtained with traditional subtractive and molding methods.

According to the present invention, this object is achieved by a method for printing a multifocal lens comprising a base lens and at least one segment lens comprising the following steps: virtually slicing the three-dimensional shape of the multifocal lens into two-dimensional layers, resulting in a number N_{base} of slices j₁, . . . , j_{Nbase} of the base lens and a number N_{segment} of slices i₁, . . . , i_{Nsegment} of the at least one segment lens; providing a number N_{finish} of layers printed as surface-finishing layers; printing the base lens in a base-lens printing step and consecutively printing the segment lens in a segment-lens printing step on top of the base lens through a targeted placement of droplets of printing ink at least partially side by side, such that in the base-lens printing step first N_{base}-N_{finish} structure layers and then N_{finish} surface-finishing layers are printed and in the segment-lens printing step first N_{segment}-N_{finish} structure layers and then N_{finish} surface-finishing layers are printed.

With this method, it is advantageously possible to print a multifocal lens of high optical quality at least matching the quality obtained with traditional subtractive or molding lens-manufacturing methods. Whereas in the conventional printing scheme, the base lens and the segment lens are built up from structure layers and consecutively covered by surface-finishing layers, according to the present invention, the segment lens is printed on surface-finishing layers covering the base lens structure. The application of surface-finishing layers before the segment-lens structure layers prevents distortion because the printing ink is hence pinned and cannot flow. In this way, a sharp transition between the base lens and the at least one segment lens can be created, resulting in a printed high-quality multifocal lens.

In the sense of the present invention, printing of an optical component comprises building up the component from layers of printing ink. These are obtained through a targeted placement of droplets of printing ink at least partially side by side. The droplets of printing ink are ejected from the nozzles of a print head, typically towards a substrate. The printing ink preferably comprises a translucent or transparent, photopolymerizable monomer. The deposited droplets may or may not be cured at intervals through exposition to ultraviolet radiation.

Multifocal lenses in the sense of the present invention comprise lenses with at least two areas of two distinct optical functions, whereas the first area is provided by the base lens and the second area is provided by the at least one segment lens. The optical function is defined by the focal point of the respective lens. The base lens and the segment lens comprise for example plane, concave, convex, biconcave, biconvex and meniscus lenses. Multifocal lenses in the sense of the present invention preferably comprise ophthalmic lenses.

Preferably, the surface-finishing layers printed during the base lens printing step are the surface-finishing layers of the base lens, i.e. they cover the surface of the entire base lens. The surface-finishing layers printed during the segment lens printing step preferably are the surface-finishing layers of the segment lens, i.e. they cover only the area of the segment lens.

According to a preferred embodiment the N_{segment}-N_{finish} structure layers printed during the segment-lens printing step correspond to the slices i_{Nfinish+1}, . . . , i_{Nsegment-Nfinish} of the at least one segment lens and the N_{finish} surface-finishing layers printed during the segment-lens printing step correspond to the slices i₁, . . . , i_{Nfinish} of the at least one segment lens. In this way, it is advantageously possible to obtain a segment lens of a shape as close as possible to the intended shape. Preferably, each of the slices i₁, . . . , i_{Nfinish} has an equal or larger surface than each of the slices slices i_{Nfinish+1}, . . . , i_{Nsegment-Nfinish}. In a preferred embodiment the first surface-finishing layer printed during the segment-lens printing step corresponds to the slice i_{Nfinish}, the second to the slice i_{Nfinish-1} etc. and the last surface-finishing layer printed during the segment-lens printing step to the slice i₁ of the at least one segment lens. Through reversing the order of slices printed as surface-finishing layers such that the smaller layers are printed first, the multifocal lens is advantageously provided with a particularly smooth surface.

In an alternative preferred embodiment wherein the surface size of the N_{finish} surface-finishing layers corresponding to the slices i₁, . . . , i_{Nfinish} of the at least one segment lens printed during the segment-lens printing step is optimized such that sharpness of the transition between base and segment lens is maximized. A sharp transition advantageously increases the quality of the printed multifocal lens.

According to a preferred embodiment at least one of the 2N_{finish} surface-finishing layers is printed in multi-pass mode. A layer which is printed in multi-pass mode is virtually divided into multiple sublayers which are printed in sublayer printing steps. During each sublayer printing step, droplets of printing ink are deposited such that the full multi-pass layer is recovered at the end of the multiple sublayer printing steps. For example, a layer printed in multi-pass mode is divided into three sublayers. During each sublayer printing step, a third of the surface of the original multi-pass layer is printed such that after the third sublayer printing step, a single droplet has been deposited at each voxel, i.e. volume element, of the multi-pass layer. The printing patterns for the sublayers are preferably randomly generated. For example, the printing patterns are provided as grids with black-and-white patterns. Each black grid cell corresponds to a voxel of the corresponding sublayer, on which a droplet of printing ink is deposited during the corresponding sublayer printing step, whereas the voxels corresponding to white grid cells are not printed onto. During the following sublayer printing step, this is reversed: droplets are deposited on voxels corresponding to white grid cells, whereas voxels corresponding to black grid cells remain empty. Such black and white printing patterns can e.g. be generated from any greyscale picture, preferably through halftoning. Through multi-pass printing, ripples and other unwanted deformations in the surface of the printed structure are advantageously reduced or altogether avoided.

In a preferred embodiment the 2N_{finish} surface-finishing layers are printed using a different printing process than used for the printing of the structure layers. In particular, the 2N_{finish} surface-finishing layers are printed using printing properties such as droplet size, printing speed, droplet density for example, that differ from the respective properties used in printing the structure layers. Herewith, it is advantageously possible to adjust the printing process defined preferably through printing properties of the surface-finishing layers to the requirements of the surface finish, e.g. with respect to smoothness, viscosity, ink spreading, ink curing, durability etc.

Preferably, the droplets of printing ink are pin cured after deposition of either the respective droplet or a whole layer. During pin curing, the deposited droplet or droplets are only partially cured. Preferably, pin curing involves an exposition to the deposited droplet or droplets to UVA light with a wave length between 315 and 380 nm, particularly UVA LED, resulting in a selective polymerization of the layer. Hence, a semi-polymerized layer body is obtained, whose top surface of the pin cured layer is less polymerized and maintains a more liquid state. This allows for a good ink acceptance in the next printing step, while the underlying part of the layer has a sufficient solid state that immobilizes the total structure.

According to a preferred embodiment the pinning energy of the N_{finish} surface-finishing layers of the base lens is optimized such that adhesion of the segment lens structure layers is maximized. The increased adhesion of the segment lens structure layers to the surface-finishing layers of the base lens minimizes the flow of the segment structure layers and hence the formation of the meniscus at the border between base and segment lens. Thus, a sharp transition between base and segment lens is obtained.

Alternatively or additionally, the pinning energy of the N_{finish} surface-finishing layers of the base lens is optimized such that sharpness of the transition between base and segment lens is maximized. With an increased pinning energy, coalescence of the surface-finishing layers is minimized and hence the formation of the meniscus at the border between base and segment lens prevented.

In a preferred embodiment, 4≤N_{finish}≤12, preferably N_{finish}=8.

Preferably, the multifocal lens is cured through exposure to ultraviolet light after the segment-lens printing step. Preferably, this is the only curing carried out during the printing procedure. Through curing, the overall structure is hardened and fixed.

Another object of the present invention is a multifocal lens printed with a method according to one of claims 1 to 13, comprising a base lens and at least one segment lens on the base lens with a sharp transition between the base and the at least one segment lens. Hence, a printed high-quality multifocal lens is provided.

### BRIEF DESCRIPTION OF THE DRAWINGS

FIG. 1 schematically illustrates a printing method and a multifocal lens printed with a printing method according to the state of the art.

FIG. 2 schematically illustrates a printing method and a multifocal lens printed with a printing method according to an exemplary embodiment of the present invention.

### DETAILED DESCRIPTION

The present invention will be described with respect to particular embodiments and with target to certain drawings but the invention is not limited thereto but only by the claims. The drawings described are only schematic and are non-limiting. In the drawings, the size of some of the elements may be exaggerated and for illustrative purposes may not be drawn to scale.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

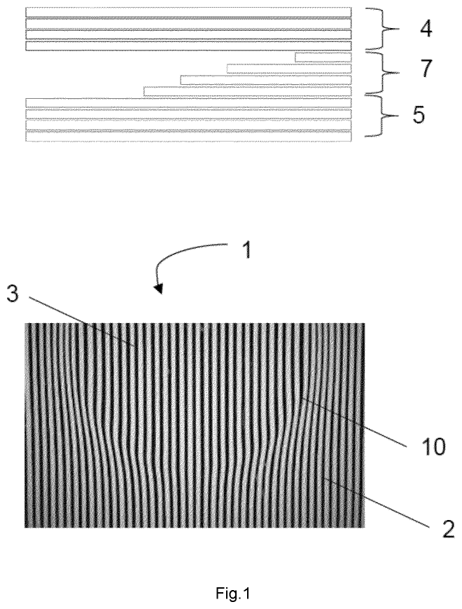

In FIG. 1 a printing method and a multifocal lens 1 printed with a printing method according to the state of the art is schematically illustrated. The multifocal lens 1 comprises a base lens 2 and at least one segment lens 3, providing the multifocal lens 1 with at least two areas of differing optical functions. For example, a bifocal lens comprises a base lens 2 and a single segment lens 3. The base lens 2 has a focal point in the far distance, so that the base lens 2 provides a far-view area or far-view field of the multifocal lens 1. The segment lens 3 is for example provided in the lower half of the base lens 2 and has a focal point in reading distance, providing a near-view area or near-view field of the multifocal lens 1. Trifocal or higher multifocal lenses 1 comprise three or more segment lenses 3. Preferably, the segment lens 3 is a convex lens. In a first preparatory step, the three-dimensional shape of the multifocal lens 1 is virtually sliced into two-dimensional slices j₁, . . . , j_{Nbase}, i₁, . . . , i_{Nsegment}. Preferably, virtual slicing is carried out on a computer by a corresponding software programme called “Slicer”. The resulting virtual slices j₁, . . . , j_{Nbase}, i₁, . . . , i_{Nsegment} serve as input for the printer. Preferably, a slicer software converts the three-dimensional shape of the multifocal lens 1 into a set of slices j₁, . . . , j_{Nbase}, i₁, . . . , i_{Nsegment} that is conveyed to the printer in machine code, e.g. G-code. The base lens 2 and the segment lens 3 are hence described by slices N_{base} slices j₁, . . . , j_{Nbase} and N_{segment} slices i₁, . . . , i_{Nsegment}, respectively. In state of the art printing methods, a number of surface-finishing layers N_{finish} is defined. Surface-finishing layers endow the printed structure with a smooth surface and ^{hence} the desired optical quality. Preferably, the number N_{finish} of surface-finishing layers is between four and 12. In a second step, the multifocal lens 1 is printed. Through ejection of droplets of printing ink from nozzles of a print head towards a substrate, layers of printing ink are formed. The printing ink is preferably transparent or translucent and photo-polymerizable, e.g. the printing ink comprises a monomer that polymerizes upon exposure to ultraviolet light. For each slice j₁, . . . , j_{Nbase-Nfinish}, i₁, . . . , i_{Nsegment-Nfinish} a structure layer is deposited, such that the structure of the multifocal lens 1 is built up from structure layers. Preferably, first, structure layers corresponding to slices slice j₁, . . . , j_{Nbase} of the base lens are printed and pin cured before the structure layers corresponding to slices i₁, . . . , i_{Nsegment-Nfinish} are deposited on top. In a third step, the N_{finish} surface-finishing layers are printed on the surface of the structure obtained in the previous step. The surface-finishing layers cover the entire surface of the structure deposited so far. The surface-finishing layers are likewise printed through a targeted placement of droplets of printing ink at least partially side by side. These droplets of printing ink are ejected from the ejection nozzles of the print head. The surface-finishing layers are deposited with the aim to create a smooth surface on the printed structure in order to endow the printed structure with the desired optical quality. In the case of a multifocal lens 1 comprising a base lens 2 and at least one segment lens 3, however, a meniscus is created at the border between the base lens 2 and the at least one segment lens 3. The meniscus forms as a result of surface tension of the deposited surface-finishing layers. The transition 10 between the base lens 2 and the at least one segment lens 3 is hence not sharp, but blurred and smoothed out, see the lower panel of FIG. 1. This results in optical aberrations compromising the quality of the printed multifocal lens 1. In current state of the art methods, the printed multifocal lens 1 is cured, e.g. through exposition to ultraviolet light, after deposition of the surface-finishing layers.

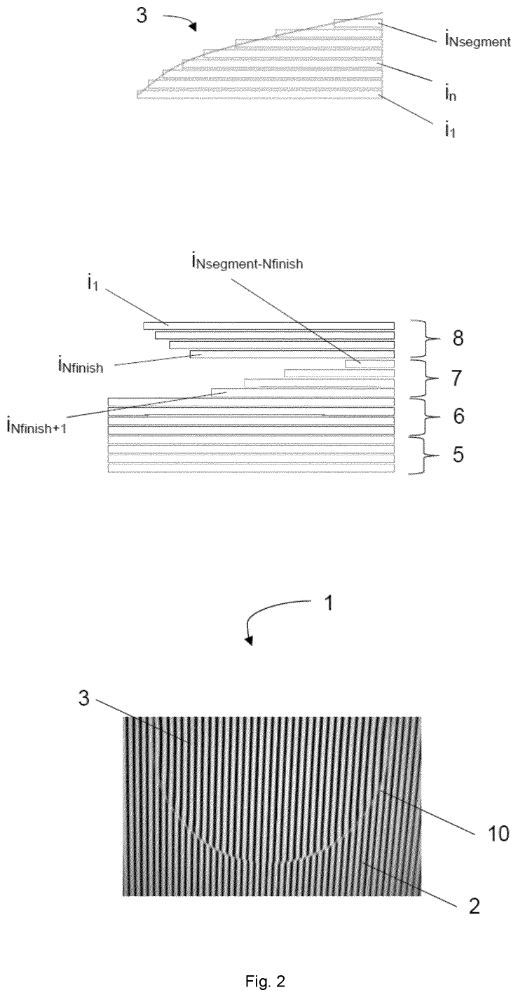

In FIG. 2 a printing method and a multifocal lens 1 printed with a printing method according to an exemplary embodiment of the present invention is schematically illustrated. The printing method differs from the state of the art printing method illustrated in FIG. 1, in the printing step. Prior to print, the shape of the multifocal lens 1 is virtually sliced into two-dimensional slices j₁, . . . , j_{Nbase}, i₁, . . . , i_{Nsegment}, which preferably serve as input for the printer. Printing is carried through a targeted placement of droplets of printing ink at least partially side by side such that layers are formed. Printed layers correspond to the two-dimensional slices obtained prior to print. The printing ink is preferably transparent or translucent and photo-polymerizable, e.g. the printing ink comprises a monomer that polymerizes upon exposure to ultraviolet light. A number N_{finish} of surface-finishing layers is provided. Preferably, 4≤N_{finish}≤12, particular preferably N_{finish}=8. Printing of surface-finishing layers is known in the state of the art and serves the purpose of establishing a smooth final surface of the printed three-dimensional optical component, here of the multifocal lens 1. In contrast to prior methodology, in the printing method according to an exemplary embodiment of the present invention, the base lens 2 is printed in a base-lens printing step, followed by a segment-lens printing step during which the segment lens 3 is printed. In the base-lens printing step, first N_{base}-N_{finish} structure layers 5 and then N_{finish} surface-finishing layers 6 are printed and in the segment-lens printing step, first N_{segment}-N_{finish} structure layers 7 and then N_{finish} surface-finishing layers 8 are printed. That means, in contrast to existing methods, in the method according to the present invention, surface-finishing layers 6 are printed prior to printing any of the segment-lens layers 7, 8. The segment lens 3 is printed on surface-finishing layers 6. This advantageously prevents the formation of a meniscus through the deposition of the surface-finishing layers 8 of the at least one segment lens 3. Hence, a sharp transition 10 results as can be seen in the lower panel in FIG. 2. Preferably, the pinning energy of the N_{finish} surface-finishing layers 6 of the base lens 2 is optimized such that adhesion of the segment lens structure layers 7 and/or the sharpness of the transition 10 between base lens 2 and at least one segment lens 3 is maximized. Preferably, the structure layers 7 of the at least one segment lens 3 correspond to the slices i_{Nfinish+1}, . . . , i_{Nsegment-Nfinish} of the at least one segment lens 3 and the N_{finish} surface-finishing layers 8 printed during the segment-lens printing step correspond to the slices i₁, . . . , i_{Nfinish} of the at least one segment lens 3. That means, preferably the first N_{finish} slices of the at least one segment lens 3 are skipped when printing the segment lens structure layers 7. These slices are preferably printed as segment lens surface-finishing layers 8 on top. This advantageously increases the sharpness of the transition 10. A further increase in sharpness is obtained if the order in which the slices are printed as surface-finishing layers 8 is reversed. Preferably, the surface-finishing layer 8 corresponding to the slice i_{Nfinish} is printed first, followed by the surface-finishing layer 8 corresponding to the slice i_{Nfinish-1} etc. and the surface-finishing layer 8 corresponding to the slice i₁ is printed last. The usual application comprises at least one convex segment lens 3. For a convex segment lens 3, the reversed order of printing of the surface-finishing layers 8 implies that the layers are printed in the order of increasing surface. Due to the flow characteristics of the printed layers, a smoother surface of the at least one segment lens 3 advantageously results. In an alternative embodiment, the surface size of the surface-finishing layers 8 is optimized with respect to the sharpness of the transition 10. I.e. the surface-finishing layers 8 are no longer determined by the size of the slices i₁, . . . , i_{Nsegment} derived from the shape of the multifocal lens 1. Preferably, at least one of the surface-finishing layers 6, 8 is printed in multi-pass mode. Multi-pass printing comprises a decomposition of a single layer 6, 8 into multiple sublayers such that through printing of all sublayers the original single layer 6, 8 is recovered. I.e. each sublayer covers only part of the original single layer 6, 8. Known in two-dimensional printing to eliminate or reduce banding effects, i.e. irregularities in colour density, its application in three-dimensional printing advantageously eliminates or reduces geometrical irregularities such as ripples and waves that otherwise may form on the surface of the printed three-dimensional structure 1, compromising the optical quality of said structure. Preferably, the printing ink and/or printing process defined by printing properties such as e.g. speed and droplet size, used when printing the surface-finishing layers 6, 8 differ from the printing ink and/or printing process and/or printing properties used when printing the structure layers 5, 7, respectively. Preferably, the multifocal lens 1 is cured through exposition to ultraviolet light at the end of the segment-lens printing step.

### KEY TO FIGURES

1 Multifocal lens
2 Base lens
3 Segment lens
4 Surface-finishing layer
5 Base lens structure layer
6 Base lens surface-finishing layer
7 Segment lens structure layer
8 Segment lens surface-finishing layer
9 Slice iₙ
10 Transition

1. A method for printing a multifocal lens comprising a base lens and at least one segment lens comprising the following steps:
virtually slicing a three-dimensional shape of the multifocal lens into two-dimensional slices, resulting in a number N_{base} of slices j₁, . . . , j_{Nbase} of the base lens and a number N_{segment} of slices i₁, . . . , i_{Nsegment} of the at least one segment lens;
providing a number N_{finish} of layers printed as surface-finishing layers;
printing the base lens in a base-lens printing step and consecutively printing the segment lens in a segment-lens printing step on top of the base lens through a targeted placement of droplets of printing ink at least partially side by side;
wherein in the base-lens printing step first N_{base}-N_{finish} structure layers and then N_{finish} surface-finishing layers are printed and in the segment-lens printing step first N_{segment}-N_{finish} structure layers and then N_{finish} surface-finishing layers are printed; and
wherein the 2N_{finish} surface-finishing layers are printed using a printing process defined by droplet size and/or printing speed and/or droplet density that differ from respective properties used in printing the structure layers.

2. The method according to claim 1, wherein the N_{segment}-N_{finish} structure layers printed during the segment-lens printing step correspond to the slices i_{Nfinish+1}, . . . , i_{Nsegment-Nfinish} of the at least one segment lens and the N_{finish} surface-finishing layers printed during the segment-lens printing step correspond to the slices i₁, . . . , i_{Nfinish} of the at least one segment lens.

3. The method according to claim 2, wherein the first surface-finishing layer printed during the segment-lens printing step corresponds to the slice i_{Nfinish}, the second to the slice i_{Nfinish-1} etc. and the last surface-finishing layer printed during the segment-lens printing step to the slice i₁ of the at least one segment lens.

4. (canceled)

5. The method according to claim 1, wherein at least one of the 2N_{finish} surface-finishing layers is printed in multi-pass mode.

6. (canceled)

7. The method according to claim 1, wherein at least one layer is pin cured through exposition to ultraviolet light, wherein during pin curing, the deposited droplet or droplets are only partially cured.

8. (canceled)

9. (canceled)

10. The method according to claim 1, wherein 4≤N_{finish}≤12.

11. The method according to claim 1, wherein the multifocal lens is cured through exposure to ultraviolet light after the segment-lens printing step.

12. A multifocal lens printed with a method according to claim 1, comprising a base lens and at least one segment lens on the base lens with a sharp transition between the base lens and the at least one segment lens, wherein the segment lens is printed on a surface-finishing layer.

13. The method according to claim 7, wherein the ultraviolet light is UVA light.

14. The method according to claim 10, wherein N_{finish}=8.
